(19) United States
(12) Patent Application Publication
(10) Pub. No.: US 2026/0168640 A1
(43) Pub. Date: Jun. 18, 2026

(54) LAMP BODY STRUCTURE

(71) Applicant: Honda Motor Co., Ltd., Tokyo (JP)

(72) Inventors: Takuma SATO, Saitama (JP); Masato NOGUCHI, Saitama (JP); Takeshi SANO, Saitama (JP)

(73) Assignee: Honda Motor Co., Ltd., Tokyo (JP)

(21) Appl. No.: 19/315,893

(22) Filed: Sep. 2, 2025

(30) Foreign Application Priority Data
Dec. 18, 2024 (CN) 202411865455.X

(51) Int. Cl. F21S 41/40; F21S 41/19; F21S 41/20; F21S 41/32; F21S 41/37

(52) U.S. Cl. CPC F21S 41/40; F21S 41/192; F21S 41/285; F21S 41/32; F21S 41/37

(57) ABSTRACT

A lamp body structure is adapted to emit light from inner to outer side of vehicle body part and includes: shell component adapted to be disposed on vehicle body part and having accommodation space; light source disposed in shell component and emitting illumination light from inner toward outer side; transparent resin layer having transparency and disposed at position closer to outer side than light source; reflective layer having reflectivity through treatment and disposed at position closer to outer side than transparent resin layer; coloring layer having color and disposed at position closer to outer side than reflective layer; non-transmissive component configured on outer side of shell component and having transmission section formed by cutting notch at a part corresponding to light source for illumination light to pass, and light source configured for illumination light emitted to pass transmission section and coloring layer to transmit to outer side as transmitted light.

### CROSS-REFERENCE TO RELATED APPLICATION

This application claims the priority benefit of China application serial no. 202411865455.X, filed on Dec. 18, 2024. The entirety of the above-mentioned patent application is hereby incorporated by reference herein and made a part of this specification.

### BACKGROUND

### Technical Field

The disclosure relates to a lamp body structure, and particularly relates to a lamp body structure adapted for a vehicle body part.

### Related Art

In recent years, efforts to provide access to sustainable transportation systems that also consider people in vulnerable positions among traffic participants, such as elderly people, disabled people, or children, are becoming active. To achieve the aforementioned purpose, research and development are being conducted to further improve traffic safety or convenience through development related to improving visibility. However, in technology for improving visibility, the illumination effect and appearance quality of lamp body structures used for body parts of vehicles are issues.

For example, the related art (for example, Japanese Utility Model Laid-Open Publication No. Hei 1-65743) discloses a structure in which a grille made of transparent resin material is subjected to semi-mirror treatment in its light transmission area. The structure may produce metallic luster through the semi-mirror treatment of the light transmission area during the day, and may light up (display) required characters or shapes at night by transmitting light from a light source to areas (light transmission area) other than the light-shielding area (non-light transmission area). However, the metallic luster corresponds to the silver appearance of the semi-mirror treatment, and exhibits the same metallic luster (silver) as the appearance when chrome plating is applied to vehicle body parts such as bumpers and grilles of vehicles. When metallic luster (silver) appearance through the light transmission area is not desired, for example, when it is desired to maintain the same appearance as the vehicle body color, then the aforementioned structure is not applicable. Furthermore, although a light-shielding coating is applied inside the grille made of transparent resin material to form a light-shielding area (non-light transmission area) to light up (display) required characters or shapes, the light-shielding coating has an upper limit in thickness, which may result in poor light-shielding properties and cause blurred boundaries between the light transmission area and the light-shielding area (light leakage). Therefore, it is necessary to improve the lamp body structure adapted for vehicle body parts.

The disclosure aims to improve the illumination effect and appearance quality of lamp body structures in order to solve the aforementioned issues. Furthermore, it contributes to the development of sustainable transportation systems by further improving traffic safety.

### SUMMARY

The disclosure provides a lamp body structure that may enhance illumination effect and appearance quality.

The disclosure provides a lamp body structure adapted to emit light from an inner side to an outer side of a vehicle body part, and includes the following. A shell component is adapted to be disposed on the vehicle body part and has an accommodation space. A light source is disposed in the shell component and emits illumination light from the inner side toward the outer side. A transparent resin layer has transparency and is disposed at a position more adjacent to the outer side than the light source. A reflective layer has reflectivity through semi-mirror treatment and is disposed at a position more adjacent to the outer side than the transparent resin layer. A coloring layer has color and is disposed at a position more adjacent to the outer side than the reflective layer. Also, a non-transmissive component is configured on the outer side of the shell component and has a transmission section formed by cutting a notch at a part corresponding to the light source for the illumination light to pass through, and the light source is configured such that the illumination light emitted passes through the transmission section and the coloring layer to transmit to the outer side as transmitted light.

Based on the above, in the lamp body structure of the disclosure, the light source disposed in the shell component emits illumination light from the inner side toward the outer side, and a transparent resin layer, a reflective layer having reflectivity through semi-mirror treatment, a coloring layer having color, and a non-transmissive component having a transmission section for the illumination light to pass through are disposed sequentially from the inner side toward the outer side, and the light source is configured such that the illumination light emitted passes through the transmission section and the coloring layer to transmit to the outer side as transmitted light. Thus, the light source is disposed on the inner side of the lamp body structure, and when the light source is illuminated, the illumination light of the light source may be colored through the coloring layer, thereby making the transmitted light transmitted to the outer side have the required color. When the light source is not illuminated, light (for example, natural light) from the outer side may be reflected to the outer side through the reflective layer, making it difficult for the light from the outer side to transmit into the shell component, thereby making it difficult to see the structure inside the shell component from the outer side. Accordingly, the lamp body structure of the disclosure may enhance illumination effect and appearance quality.

To make the foregoing features and advantages of the disclosure more comprehensible, embodiments are specifically provided below and described in detail together with the accompanying drawings as follows.

### BRIEF DESCRIPTION OF THE DRAWINGS

FIG. 1 is a front view schematic diagram of a vehicle with a vehicle body part applying a lamp body structure according to an embodiment of the disclosure.

FIG. 2 is a cross-sectional schematic diagram of the lamp body structure shown in FIG. 1 cut at a cross sectional line I-I′.

FIG. 3 is a partial enlarged schematic diagram of the lamp body structure shown in FIG. 2.

FIG. 4 and FIG. 5 are partial enlarged schematic diagrams of the lamp body structure shown in FIG. 3 in other modified examples.

### DESCRIPTION OF THE EMBODIMENTS

In an embodiment of the disclosure, the non-transmissive component and the shell component are connected to each other to form a light shield surrounding the transmission section.

In an embodiment of the disclosure, the non-transmissive component and the shell component are connected to each other to form multiple light shields, multiple light sources corresponding to the light shields are installed in the shell component, the non-transmissive component forms multiple transmission sections by cutting the notch, and the transmission sections and the transparent resin layer are bonded to each other.

In an embodiment of the disclosure, an edge of the transmission section of the non-transmissive component is formed with an inclined section that is inclined in an irradiation direction.

In an embodiment of the disclosure, the inclined section is inclined toward the inner side in the irradiation direction.

In an embodiment of the disclosure, the inclined section is inclined toward the outer side in the irradiation direction.

In an embodiment of the disclosure, the inclined section has an outer inclined section that is inclined toward the outer side in the irradiation direction, and an inner inclined section that is inclined toward the inner side in the irradiation direction, and the outer inclined section and the inner inclined section are inclined at different angles with respect to horizontal level as reference.

In an embodiment of the disclosure, an outer side surface of the transparent resin layer is formed with a recessed portion that is recessed from the outer side toward the inner side.

In an embodiment of the disclosure, the shell component has a separate portion extending from the inner side toward the outer side, an edge of the transmission section of the non-transmissive component is disposed on a side adjacent to the illumination light through the separate portion, and a step difference is formed between the edge and the separate portion.

In an embodiment of the disclosure, the vehicle body part includes an exterior component of a vehicle.

In an embodiment of the disclosure, the coloring layer has the same color as the vehicle body part or an adjacent item.

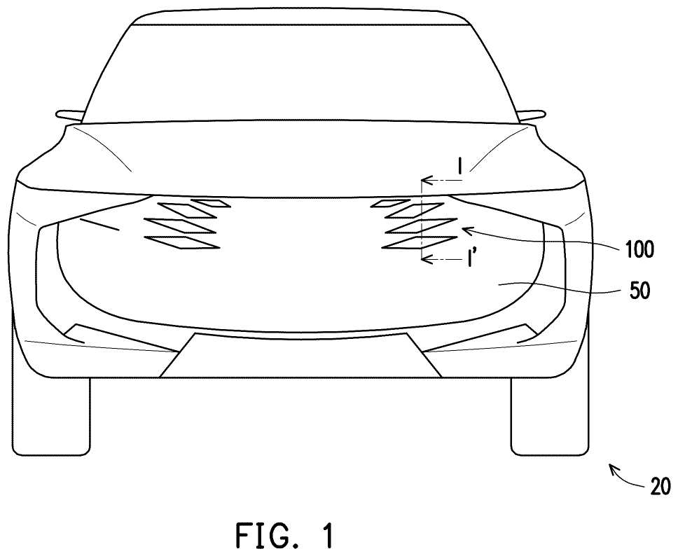

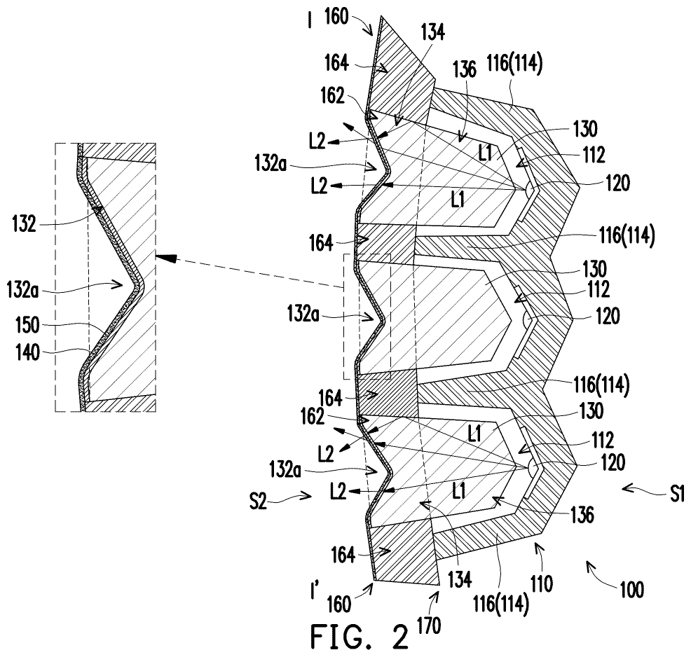

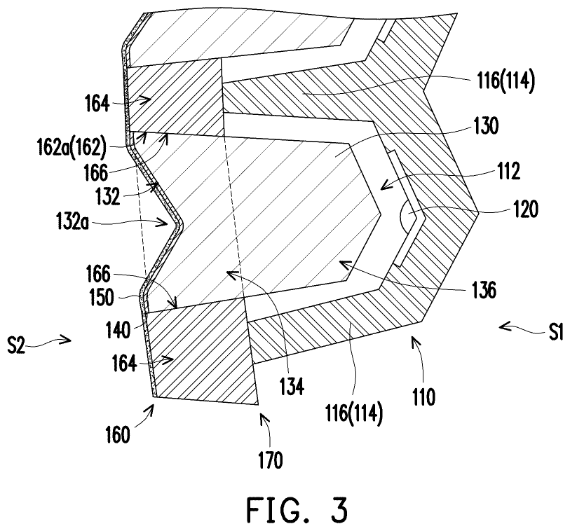

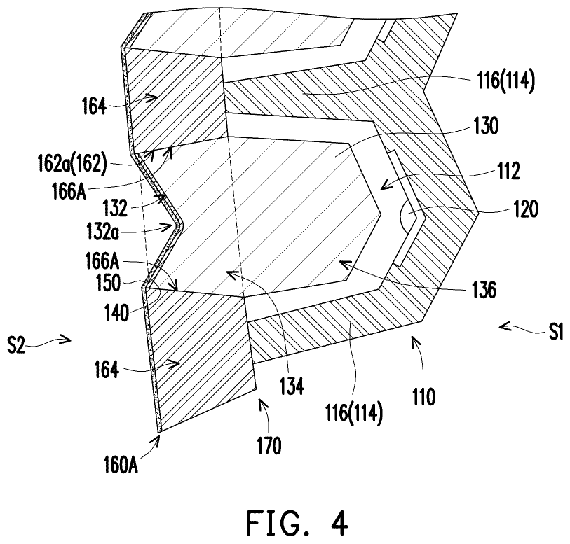

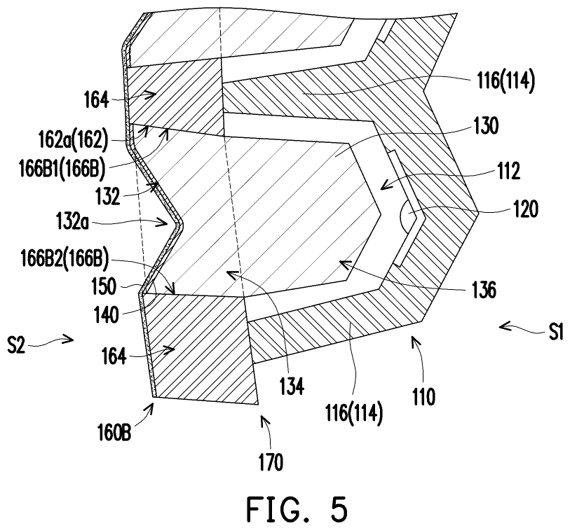

Reference will now be made in detail to exemplary embodiments of the disclosure, examples of the exemplary embodiments are illustrated in the accompanying drawings, in which FIG. 1 is a front view schematic diagram of a vehicle with a vehicle body part applying a lamp body structure according to an embodiment of the disclosure, FIG. 2 is a cross-sectional schematic diagram of the lamp body structure shown in FIG. 1 cut at a cross sectional line I-I′, FIG. 3 is a partial enlarged schematic diagram of the lamp body structure shown in FIG. 2, and FIG. 4 and FIG. 5 are partial enlarged schematic diagrams of the lamp body structure shown in FIG. 3 in other modified examples. The specific structure of a lamp body structure 100 of the present embodiment and other possible modified examples will be described below with reference to FIG. 1 to FIG. 5, but the embodiments are merely some examples of the disclosure, and the disclosure is not limited thereto.

Referring to FIG. 1 and FIG. 2, in the present embodiment, the lamp body structure 100 is adapted to emit light from an inner side S1 to an outer side S2 of a vehicle body part 50, and includes a shell component 110, a light source 120, a transparent resin layer 130, a reflective layer 140, a coloring layer 150, and a non-transmissive component 160. The shell component 110 is adapted to be disposed on the vehicle body part 50, and has an accommodation space 112. The light source 120 is disposed in the shell component 110, and emits illumination light L1 from the inner side S1 toward the outer side S2. The transparent resin layer 130 has transparency, and is disposed at a position more adjacent to the outer side S2 than the light source 120. The reflective layer 140 has reflectivity through semi-mirror treatment, and is disposed at a position more adjacent to the outer side than S2 than the transparent resin layer 130. The coloring layer 150 has color, and is disposed at a position more adjacent to the outer side than S2 than the reflective layer 140. The non-transmissive component 160 is configured on the outer side of the shell component 110, and has a transmission section 162 formed by cutting a notch at a part corresponding to the light source 120 for the illumination light L1 to pass through, and the light source 120 is configured such that the illumination light L1 emitted passes through the transmission section 162 and the coloring layer 150 to transmit to the outer side S2 as transmitted light L2.

Specifically, in the present embodiment, as shown in FIG. 1 and FIG. 2, the vehicle body part 50 refers to a partial structure mounted on a moving body such as a vehicle 20, and the lamp body structure 100 is disposed on the vehicle body part 50 to provide illumination. In the embodiment, the shell component 110 constitutes a cover structure recessed from the outer side S2 to the inner side S1, and the recessed part forms the accommodation space 112. The light source 120 is disposed, for example, at the bottom of the shell component 110 and positioned at the inner side S1 of the accommodation space 112. In contrast, the transparent resin layer 130 having transparency, the reflective layer 140 having reflectivity through semi-mirror treatment, and the coloring layer 150 having color are disposed sequentially at positions more adjacent to the outer side S2 than the light source 120. Here, the transparent resin layer 130 is disposed in the accommodation space 112 and corresponds to the light source 120, and the reflective layer 140 and the coloring layer 150 are disposed on the surface of the transparent resin layer 130 corresponding to the outer side S2. The reflective layer 140 processed through semi-mirror treatment has reflectivity to light (for example, natural light) from the outer side S2, but has no reflectivity to light (for example, illumination light L1) from the inner side S1. The color of the coloring layer 150 may be adjusted according to requirements. In addition, the non-transmissive component 160 is, for example, a frame component having multiple notches, the notches form a transmission section 162, and is disposed on the shell component 110 with a peripheral area 164 surrounding the notches. Thus, the illumination light L1 emitted by the light source 120 illuminates from the inner side S1 to the outer side S2, thereby passing through the transparent resin layer 130, the reflective layer 140, the coloring layer 150, and the transmission sections 162 of the non-transmissive component 160 (as shown by the arrows in FIG. 2) and transmitting to the outer side S2 as the transmitted light L2.

Through the above configuration, in the lamp body structure 100 of the present embodiment, the light source 120 disposed in the shell component 110 emits the illumination light L1 from the inner side S1 toward the outer side S2, and the transparent resin layer 130, the reflective layer 140 having reflectivity through semi-mirror treatment, the coloring layer 150 having color, and the non-transmissive component 160 having the transmission section 162 for the illumination light L1 to pass through are disposed sequentially from the inner side S1 toward the outer side S2, and the light source 120 is configured such that the illumination light L1 emitted passes through the transmission sections 162 and the coloring layer 150 to transmit to the outer side S2 as the transmitted light L2. Thus, the light source 120 is disposed on the inner side S1 of the lamp body structure 100, and when the light source 120 is illuminated, the illumination light L1 of the light source 120 may be colored through the coloring layer 150, thereby making the transmitted light L2 transmitted to the outer side S2 have the required color. When the light source 120 is not illuminated, light (for example, natural light) from the outer side may be reflected to the outer side S2 through the reflective layer 140, making it difficult for the light from the outer side S2 to transmit into the shell component 110, thereby making it difficult to see the structure inside the shell component 110 from the outer side S2. Accordingly, the lamp body structure 100 may enhance illumination effect and appearance quality.

More specifically, in the present embodiment, as shown in FIG. 1 and FIG. 2, the vehicle body part 50 includes an exterior component (for example, bumpers, grilles, side steps) of the vehicle 20, and the coloring layer 150 has the same color as the vehicle body part 50 or an adjacent item (for example, vehicle body structures such as vehicle body covers around the vehicle body part 50). As an example, an outer surface of the non-transmissive component 160 is also provided with the coloring layer 150. The coloring layer 150 extends continuously on an outer side surface of the reflective layer 140 and the outer surface of the non-transmissive component 160, and the color of the coloring layer 150 corresponds to the appearance color of the vehicle body structure. In the case where the lamp body structure 100 is applied to the exterior component (for example, bumpers, grilles, side steps) serving as the vehicle body part 50, when the light source 120 is illuminated, the illumination light L1 of the light source 120 may be colored through the coloring layer 150, thereby making the transmitted light L2 transmitted to the outer side S2 have the required color. When the light source 120 is not illuminated, light (for example, natural light) from the outer side is reflected to the outer side S2 through the reflective layer 140 and is difficult to transmit into the shell components 110, thereby making it difficult to see the structure inside the shell component 110 from the outer side S2. Moreover, when the light source 120 is not illuminated, the lamp body structure 100 shows the color of the coloring layer 150 from the outer side S2. Thus, regardless of whether the light source 120 of the lamp body structure 100 is illuminated or not, the lamp body structure 100 may have an assimilated appearance (for example, the same color as the vehicle body part 50 or the adjacent item) with the exterior component serving as the vehicle body part 50, thereby improving the freedom of light source configuration for the lamp body structure 100 of the vehicle 20. Accordingly, the lamp body structure 100 may improve appearance quality. However, the disclosure does not limit the specific structure, type of the vehicle body part 50, and the color of the coloring layer 150, which may be adjusted according to requirements.

Furthermore, in the present embodiment, as shown in FIG. 2 and FIG. 3, the non-transmissive component 160 and the shell component 110 are connected to each other to form a light shield 170 surrounding the transmission section 162. In the embodiment, the non-transmissive component 160 is directly disposed on sidewalls 114 surrounding the accommodation space 112 of the shell components 110 with a peripheral area 164, and the non-transmissive component 160 and at least a part of the shell component 110 are connected to each other to constitute the light shield 170 that continuously shields the illumination light L1. Thus, when the light source 120 is not illuminated, light (for example, natural light) from the outer side is reflected to the outer side S2 through the reflective layer 140 and is difficult to transmit into the light shield 170, thereby making it difficult to see the structure inside the light shield 170 from the outer side S2. When the light source 120 is illuminated, the illumination light L1 of the light source 120 may illuminate toward the irradiation direction (that is, the direction from the inner side S1 toward the outer side S2) through the restriction of the light shield 170, and the lamp body structure 100 may suppress the illumination light L1 of the light source 120 from exceeding the light shield 170 and transmitting to the outer side S2 from other parts (for example, the transmission section of another set of structures in multiple sets of structures) through the light shield 170, thereby improving the illumination effect. However, the disclosure does not limit the specific structure of the light shield 170, which may be adjusted according to requirements.

Furthermore, in the present embodiment, as shown in FIG. 2 and FIG. 3, the shell component 110 has a separate portion 116 (for example, constituted by the sidewall 114) extending from the inner side S1 toward the outer side S2, and an edge 162a of the transmission section 162 of the non-transmissive component 160 is disposed on a side (that is, extending toward the middle area) adjacent to the illumination light L1 through the separate portion 116, and a step difference is formed between the edge 162a and the separate portion 116. The non-transmissive component 160 is directly disposed on the separate portion 116 of the shell component 110 with the peripheral area 164, and the width of the peripheral area 164 is greater than the width of the sidewall 114 of the shell component 110, so that at least the inner edge part (corresponding to the edge 162a of the transmission section 162) of the peripheral area 164 of the non-transmissive component 160 protrudes toward the middle area more adjacent to the illumination light L1 compared to the separate portion 116 of the shell component 110. Thus, when the light source 120 is illuminated, the illumination light L1 of the light source 120 may increase the number of reflections through the step difference between the edge 162a and the separate portion 116, thereby adjusting the light amount of the transmitted light L2 (it is assumed that when the number of reflections increases, the light amount of the transmitted light L2 also increases). However, the disclosure does not limit the specific structure of the shell components 110, which may be adjusted according to requirements.

As an example, in the present embodiment, as shown in FIG. 2, the shell component 110 has multiple separate portions 116 constituted by multiple sidewalls 114, thereby forming multiple accommodation spaces 112. The accommodation spaces 112 may have the same structural configuration, for example, each configured with a light source 120, a transparent resin layer 130, a reflective layer 140, and a coloring layer 150 (so that the lamp body structure 100 has multiple sets of combinations of light source 120, transparent resin layer 130, reflective layer 140, and coloring layer 150), but in other embodiments not shown, at least one accommodation space 112 may also have a different structural configuration. The sets of light sources 120 may be controlled separately to be illuminated or not, for example, illuminating a first set and a third set of light sources 120 shown in FIG. 2 while a second set of light source 120 is not illuminated (darkened). Furthermore, the non-transmissive component 160 may be a single component having multiple transmission sections 162 respectively corresponding to the light sources 120 in the accommodation spaces 112 and a peripheral area 164 surrounding the transmission sections 162, but in other embodiments not shown, multiple non-transmissive components 160 each having a single transmission section 162 may also be respectively disposed on the separate portion 116. Thus, the lamp body structure 100 may enhance illumination effect. However, in other embodiments not shown, the lamp body structure may also have merely one accommodation space 112 and be provided with merely one set of light source 120, transparent resin layer 130, reflective layer 140, coloring layer 150, and non-transmissive component 160.

Furthermore, in the present embodiment, as shown in FIG. 2 and FIG. 3, the non-transmissive component 160 and the shell component 110 are connected to each other to form multiple light shields 170, multiple light sources 120 corresponding to the light shields 170 are installed in the shell component 110, the non-transmissive component 160 forms multiple transmission sections 162 by cutting the notch, and the transmission sections 162 and the transparent resin layer 130 are bonded to each other. An outer side surface 132 of the transparent resin layer 130 is formed with a recessed portion 132a that is recessed the outer side S2 toward the inner side S1. As an example, an inner end 134 of the transparent resin layer 130 is disposed at a spaced interval with respect to the light source 120, an outer end 136 of the transparent resin layer 130 extends into the transmission section 162 of the non-transmissive component 160, and the side surface of the outer end 136 abuts against the edge 162a of the transmission section 162. Furthermore, the reflective layer 140 and the coloring layer 150 are disposed on the recessed portion 132a of the outer side surface 132 of the transparent resin layer 130 corresponding to the outer end 136. Thus, the lamp body structure 100 integrates two separate components by bonding the transparent resin layer 130 to the transmission section 162 formed by cutting the notch in the non-transmissive component 160, thereby enabling the use of a transparent resin layer 130 of required dimensions (that is, the outer end 136 of the transparent resin layer 130 may be recessed toward the inner side S1 compared to the transmission section 162, or may protrude toward the outer side S2 compared to the transmission section 162) without being limited by the dimensions or thickness of the transmission section 162 of the non-transmissive component 160. Moreover, by manufacturing and connecting two separate components as one body, the transparent resin layer 130 may be set to correspond to an applied vehicle parts 60 (for example, a grille having a recessed shape) without being limited by the moldability of the non-transmissive component 160 (that is, the transparent resin layer 130 of required shape may be manufactured first before bonding the transparent resin layer 130 to the transmission section 162 of the non-transmissive component 160). Accordingly, the lamp body structure 100 may enhance illumination effect and appearance quality. However, the disclosure does not limit the specific structure of, for example, the transparent resin layer 130 and the non-transmissive component 160, which may be adjusted according to requirements.

Furthermore, in the present embodiment, as shown in FIG. 3, the edge 162a of the transmission section 162 of the non-transmissive component 160 is formed with an inclined section 166 that is inclined in an irradiation direction (that is, the direction from the inner side S1 toward the outer side S2). Thus, the illumination light L1 emitted by the light source 120 may be reflected to a required angle through the inclined section 166 disposed at the edge 162a of the transmission section 162. As an example, the inclined section 166 is inclined toward the outer side S2 (that is, the right side in FIG. 3) in the irradiation direction. Thus, when the inclined section 166 is inclined toward the outer side S2 (away from the light source 120), it is difficult for the illumination light L1 to be reflected by the inclined section 166 without being shielded by the inclined section 166, whereby the transmitted light L2 transmitted toward the outer side S2 presents fan-shaped diffusion to obtain transmitted light L2 that is blurred at both opposite ends. The blurred transmitted light L2 has high diffusivity, and therefore is adapted for a lamp body structure that is not dazzling even when viewed directly. In contrast, in the modified example shown in FIG. 4, an inclined section 166A of the non-transmissive component 160A is inclined toward the inner side S1 (that is, the left side in FIG. 4) in the irradiation direction. Thus, when the inclined section 166A is inclined toward the inner side S1 (facing the light source 120), the illumination light L1 may be reflected by the inclined section 166A to concentrate toward the central area, thereby suppressing diffusion generated at both opposite ends of the transmitted light L2 transmitted toward the outer side S2 to obtain clear transmitted light L2. The clear transmitted light L2 has high visibility and visual recognition, and therefore is adapted for a lamp body structure for illuminating a specific area. However, the disclosure does not limit the specific structure of the inclined section 166 and the inclined section 166A, and whether or not the components are disposed, which may be adjusted according to requirements.

Furthermore, in the modified example shown in FIG. 5, an inclined section 166B of a non-transmissive component 160B has an outer inclined section 166B1 that is inclined toward the outer side S2 (for example, corresponding to the upper side) in the irradiation direction, and an inner inclined section 166B2 that is inclined toward the inner side S1 (for example, corresponding to the lower side) in the irradiation direction, and the outer inclined section 166B1 and the inner inclined section 166B2 are inclined at different angles with respect to horizontal level as reference. As an example, the inclination angle of the outer inclined section 166B1 with respect to horizontal level as reference is greater than the inclination angle of the inner inclined section 166B2 with respect to horizontal level as reference. Thus, when the inclined section 166B has the outer inclined section 166B1 and the inner inclined section 166B2, the transmitted light L2 near the outer inclined section 166B1 with a large inclination angle is diffused, thereby becoming blurred light, while the transmitted light L2 near the inner inclined section 166B2 with a small inclination angle is not diffused, thereby becoming clear light. When the object illuminated by the transmitted light L2 is a person in front of the vehicle, or the person is at a distant position, then the transmitted light L2 is concentrated within the set inclination angle, and therefore visibility and visual recognition may be enhanced with the clear transmitted light L2. When a head of a person approaches a distance outside the set inclination angle, the blurred transmitted light L2 with a wide light amount attenuation range may prevent the transmitted light L2 from dazzling the eyes of the person. Although the inclination angle is set with the up-down direction as the irradiation direction here, in embodiments not shown, the inclination angle may also be set with the left-right direction, or a combination of the up-down direction and the left-right direction. However, the disclosure does not limit the specific structure of the inclined section 166B, and whether or not the component is disposed, which may be adjusted according to requirements.

In summary, in the lamp body structure of the disclosure, the light source disposed in the shell component emits illumination light from the inner side toward the outer side, and a transparent resin layer, a reflective layer having reflectivity through semi-mirror treatment, a coloring layer having color, and a non-transmissive component having a transmission section for the illumination light to pass through are disposed sequentially from the inner side toward the outer side, and the light source is configured such that the illumination light emitted passes through the transmission section and the coloring layer to transmit to the outer side as transmitted light. Thus, the light source is disposed on the inner side of the lamp body structure, and when the light source is illuminated, the illumination light of the light source may be colored through the coloring layer, thereby making the transmitted light transmitted to the outer side have the required color. When the light source is not illuminated, light (for example, natural light) from the outer side may be reflected to the outer side through the reflective layer, making it difficult for the light from the outer side to transmit into the shell component, thereby making it difficult to see the structure inside the shell component from the outer side. Furthermore, the non-transmissive component and the shell component are connected to each other to form a light shield surrounding the transmission section, thereby enhancing the light shielding effect, and the vehicle body part includes the exterior component of the vehicle, and the coloring layer has the same color as the vehicle body part or an adjacent item, thereby enhancing appearance. Accordingly, the lamp body structure of the disclosure may enhance illumination effect and appearance quality.

Finally, it should be noted that the foregoing embodiments are merely used to illustrate the technical solutions of the disclosure, and the embodiments are not intended to limit the disclosure. Although the disclosure has been described in detail with reference to the foregoing embodiments, persons of ordinary skill in the art should understand that they may still modify the technical solutions described in the foregoing embodiments, or perform equivalent substitutions for some or all of the technical features thereof; and these modifications or substitutions do not cause the essence of the corresponding technical solutions to depart from the scope of the technical solutions of the embodiments of the disclosure.

What is claimed is:

1. A lamp body structure adapted to emit light from an inner side to an outer side of a vehicle body part, comprising:
a shell component adapted to be disposed on the vehicle body part and having an accommodation space;
a light source disposed in the shell component and emitting illumination light from the inner side toward the outer side;
a transparent resin layer having transparency and disposed at a position more adjacent to the outer side than the light source;
a reflective layer having reflectivity through semi-mirror treatment and disposed at a position more adjacent to the outer side than the transparent resin layer;
a coloring layer having color and disposed at a position more adjacent to the outer side than the reflective layer; and
a non-transmissive component configured on the outer side of the shell component and having a transmission section formed by cutting a notch at a part corresponding to the light source for the illumination light to pass through, wherein
the light source is configured such that the illumination light emitted passes through the transmission section and the coloring layer to transmit to the outer side as transmitted light.

2. The lamp body structure according to claim 1, wherein
the non-transmissive component and the shell component are connected to each other to form a light shield surrounding the transmission section.

3. The lamp body structure according to claim 2, wherein
the non-transmissive component and the shell component are connected to each other to form a plurality of light shields,
a plurality of light sources corresponding to the light shields are installed in the shell component,
the non-transmissive component forms a plurality of transmission sections by cutting the notch, and
the transmission sections and the transparent resin layer are bonded to each other.

4. The lamp body structure according to claim 1, wherein
an edge of the transmission section of the non-transmissive component is formed with an inclined section that is inclined in an irradiation direction.

5. The lamp body structure according to claim 4, wherein
the inclined section is inclined toward the inner side in the irradiation direction.

6. The lamp body structure according to claim 4, wherein
the inclined section is inclined toward the outer side in the irradiation direction.

7. The lamp body structure according to claim 4, wherein
the inclined section has an outer inclined section that is inclined toward the outer side in the irradiation direction, and an inner inclined section that is inclined toward the inner side in the irradiation direction, and
the outer inclined section and the inner inclined section are inclined at different angles with respect to horizontal level as reference.

8. The lamp body structure according to claim 2, wherein
an edge of the transmission section of the non-transmissive component is formed with an inclined section that is inclined in an irradiation direction.

9. The lamp body structure according to claim 8, wherein
the inclined section is inclined toward the inner side in the irradiation direction.

10. The lamp body structure according to claim 8, wherein
the inclined section is inclined toward the outer side in the irradiation direction.

11. The lamp body structure according to claim 8, wherein
the inclined section has an outer inclined section that is inclined toward the outer side in the irradiation direction, and an inner inclined section that is inclined toward the inner side in the irradiation direction, and
the outer inclined section and the inner inclined section are inclined at different angles with respect to horizontal level as reference.

12. The lamp body structure according to claim 3, wherein
an edge of the transmission section of the non-transmissive component is formed with an inclined section that is inclined in an irradiation direction.

13. The lamp body structure according to claim 12, wherein
the inclined section is inclined toward the inner side in the irradiation direction.

14. The lamp body structure according to claim 12, wherein
the inclined section is inclined toward the outer side in the irradiation direction.

15. The lamp body structure according to claim 12, wherein
the inclined section has an outer inclined section that is inclined toward the outer side in the irradiation direction, and an inner inclined section that is inclined toward the inner side in the irradiation direction, and
the outer inclined section and the inner inclined section are inclined at different angles with respect to horizontal level as reference.

16. The lamp body structure according to claim 1, wherein
an outer side surface of the transparent resin layer is formed with a recessed portion that is recessed from the outer side toward the inner side.

17. The lamp body structure according to claim 2, wherein
an outer side surface of the transparent resin layer is formed with a recessed portion that is recessed from the outer side toward the inner side.

18. The lamp body structure according to claim 1, wherein
the shell component has a separate portion extending from the inner side toward the outer side, and
an edge of the transmission section of the non-transmissive component is disposed on a side adjacent to the illumination light through the separate portion, and a step difference is formed between the edge and the separate portion.

19. The lamp body structure according to claim 1, wherein
the vehicle body part comprises an exterior component of a vehicle.

20. The lamp body structure according to claim 1, wherein
the coloring layer has same color as the vehicle body part or an adjacent item.
